(19) United States
(12) Patent Application Publication
(10) Pub. No.: US 2006/0263215 A1
(43) Pub. Date: Nov. 23, 2006

(54) ROLL STABILISED UNIT

(76) Inventors: Oliver Sindt, Chellenham (GB); Slim Hbaieb, Paris (FR); Geoff Downton, Minchinhampton (GB); Robert Ian Robson, Chellenham (GB); Steven Hart, Brimsham Park (GB)

Correspondence Address: SCHLUMBERGER OILFIELD SERVICES, 200 GILLINGHAM LANE, MD 200-9, SUGAR LAND, TX, 77478, US

(21) Appl. No.: 11/383,084

(22) Filed: May 12, 2006

(30) Foreign Application Priority Data
May 21, 2005 (GB) 0510480.7

(51) Int. Cl. F03D 7/02

(52) U.S. Cl. 416/9

(57) ABSTRACT

A roll stabilised unit comprises a tool housing (30) rotatably mounted within a tool collar (28), the tool housing (30) having rotatably mounted thereon a first impeller (36), a variable torque transmission arrangement (38) being provided to allow the torque transmitted from the first impeller (36) to the housing (30) to be controlled, and a second impeller (40) fixed relative to the housing (30) so as to be rotatable with the housing (30).

Cross reference to related application, this application claims priority from the UK Application Number 0510480.7, filed on 21 May 2005.

This invention relates to a roll stabilised unit for use in a downhole directional or steerable drilling system.

### BACKGROUND

A known form of directional or steerable drilling system includes a bias unit having a plurality of bias pads mounted thereon or associated therewith, each pad being moveable between a radially retracted position and an extended position. In its extended position, each pad bears against the surface of the borehole being formed, and thereby applies a sideways acting load to the bias unit, and to other downhole components, including a drill bit, connected thereto.

The bias pads are typically moveable by means of associated pistons to which drilling fluid or mud under pressure is supplied, in turn, as the bias unit rotates, through an associated control valve. One form of control valve used in this type of application is a rotary valve having a rotatable control shaft associated therewith.

The control valve is designed such that, in use, if the control shaft is held against rotation then, as the bias unit rotates, the bias pads move between their retracted and extended positions synchronously with the rotation of the bias unit. As a result, the sideways acting load acts in substantially the same direction over a period of time, leading to the formation of a curve in the path followed by the borehole in a desired direction. To achieve a change in the direction of curvature, the control shaft is rotated to a new position, and subsequently held in substantially that position, so as to change the direction in which the load is applied to a new desired direction.

In order to hold the control shaft against rotation, a roll stabilised platform is used. One form of know roll stabilised platform comprises a housing containing sensors and associated control circuits, the housing having rotatable mounted thereon a pair of rotatable impellors. The housing is located within a tubular tool collar through suitable bearings so as to allow the housing to rotate.

In use, drilling fluid is supplied through the collar, the fluid impinging upon the impellors to cause rotation thereof relative to the housing. The rotation of the impellors is used to generate electricity to power the sensors and circuits of the tool.

The connection of the impellors to the housing will tend to slow the movement of the impellors relative to the housing, thereby applying a torque tending to cause the housing to rotate. The connections are designed to allow the degree of slowing, and hence the magnitude of the applied torque, to be variable, with the result that movement of the housing and hence the angular position occupied by the housing, can be controlled.

The control shaft is connected to the housing and it will thus be appreciated that the angular position of the control shaft can also be controlled.

It is desired to reduce the number of impellors provided so as to reduce cost and also simplify maintenance of the tool. U.S. Pat. No. 5,265,682 describes a tool having a single impellor, but this tool is of restricted application as it can only be positively driven for rotation in a single direction.

### SUMMARY OF INVENTION

According to the present invention there is provided a roll stabilised unit comprising a tool housing rotatably mounted within a tool collar, the tool housing having rotatably mounted thereon a first impeller, a variable torque transmission arrangement being provided to allow the torque transmitted from the first impeller to the housing to be controlled, and a second impeller fixed relative to the housing so as to be rotatable with the housing.

The provision of the second, fixed impeller allows the tool to be used in wide range of applications, as the tool can be positively driven in both rotary directions, whilst being of relatively low cost and relatively simple to maintain compared to conventional arrangements.

The first and second impellers include impeller blades, the blades of the first impeller conveniently being angled relative to those of the second impeller such that, in use, the torque forces applied to the housing by the first and second impellers are in opposing directions.

The design of the first and second impellers is conveniently such that the maximum torque capable of being applied to the housing by the first impellor is greater than the opposing torque experienced by the housing. The opposing torque may include that applied by the second impeller, and other frictional torques generated in the tool.

### BRIEF DESCRIPTION OF DRAWINGS

The invention will further be described, by way of example, with reference to the accompanying drawings, in which:

FIG. 1 is a diagrammatic view of part of a steerable or directional drilling system; and

FIG. 2 is a diagrammatic view of a roll stabilised unit in accordance with one embodiment of the invention.

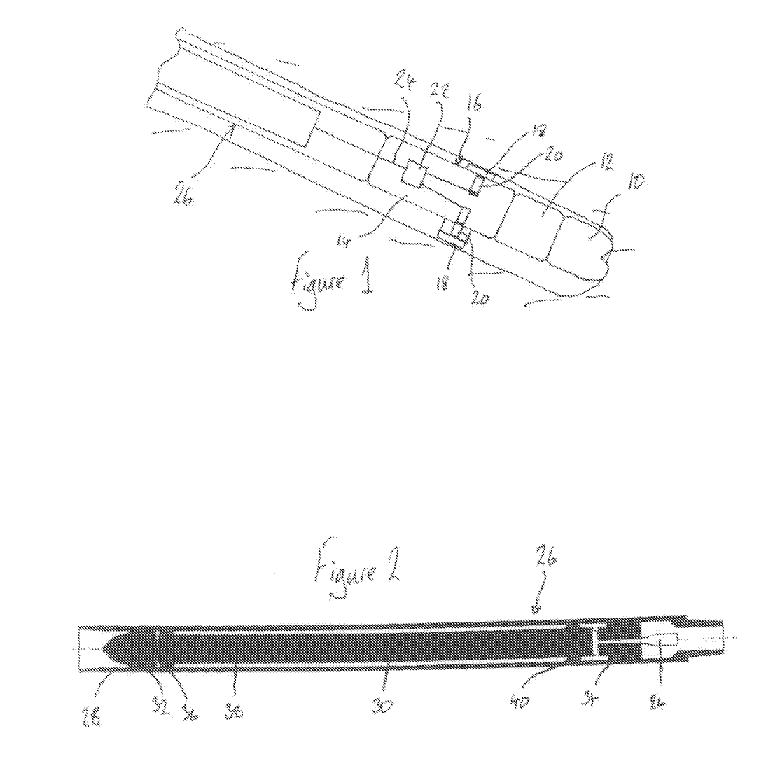

### DESCRIPTION OF PREFERRED EMBODIMENT

Referring to the accompanying drawings, a steerable or directional drilling system comprises a rotatable drill bit 10 driven for rotation by a downhole motor 12. The motor 12 is connected to the tool collar 14 of a bias unit 16. The bias unit 16 includes a series of bias pads 18, each bias pad 18 being movable by an associated piston arrangement 20 between a retracted position and an extended position in which is bears against the surface of the borehole being formed. It will be appreciated that when one of the bias pads 18 is forced against the surface of the borehole, a reaction force is experienced by the remainder of the bias unit 16, the reaction force urging the bias unit sideways relative to the borehole. As the downhole motor 12 and drill bit 10 are connected to the bias unit, these components also experience the reaction force, and the result of this is to urge the drill bit 10 to form a deviation in the path of the drill bit.

It will be appreciated that if the bias unit is controlled in such a manner that the pads 18 are moved to their extended positions in turn, in synchronism with the rotation of the bias unit, in use, then the reaction force will be applied in a substantially constant direction, and that this direction can be controlled, thereby enabling control over the drilling direction.

The piston arrangements 20 are arranged to be supplied with drilling fluid or mud under pressure through a rotary control valve 22. The operation of the control valve 22 is controlled by a control shaft 24, with the result that the selection of which pad or pads 18 occupy their extended positions at any given time is dependent upon the angular position of the control shaft 24.

A roll stabilised unit 26 is used to control the angular position occupied by the control shaft 24. As illustrated in FIG. 2, the roll stabilised unit 26 comprises a tool collar 28 of tubular form. Within the tool collar 28 is located a housing 30. The housing 30 houses a number of sensors and associated circuitry. The sensors may include accelerometers, magnetometers, and sensors adapted to allow the rotation rate of the tool collar 28 to be sensed. However, it will be appreciated that other sensors could be incorporated, in addition to or instead of, these sensors. The housing 30 is supported within the tool collar 28 by means of first and second hangers 32, 34. The hangers 32, 34 incorporate suitable bearings such that the housing 30 is free to rotate within the tool collar 28 but so as to prevent or limit axial movement of the housing 30. As illustrated, the control shaft 24 of the control valve 22 is rigidly secured to the housing 30 so as to be rotatable or angularly moveable therewith.

A first impeller 36 is rotatably mounted upon the housing 30 through a control torquer device 38. A second impeller 40 is rigidly, non-rotatably, mounted upon the housing 30. The first and second impellers 36, 40 each include a series of impeller blades, the orientation of which is such that, in use, a flow of fluid through the tool collar 28 causes the first and second impellers 36, 40 to apply torque forces to the housing 30, the torque force applied by the first impeller 36 being in the opposite direction to that applied by the second impeller 40.

The rotation of the first impeller 36 relative to the housing 30 is used to generate electricity used to operate the sensors and circuits located within the housing 30.

The control torquer device 38 is operable, in response to signals applied thereto by the circuits located within the housing 30, to control the magnitude of the torque force applied by the first impeller 36 to the housing 30.

One form of control torquer device 38 is electromagnetically operable to control the magnitude of the torque force transmitted to the housing 30 from the first impellor 36, but other arrangements are also possible.

In use, fluid is supplied through the tool collar 28, the fluid impinging upon the blades of the impellers 36, 40 with the result that the impellers 36, 40 apply torque forces to the housing 30. The torque force applied by the second impeller 40 is dependent upon the fluid flow rate, fluid density and viscosity and the dimensions and profiles of the impeller blades. The torque force applied by the first impeller 26 will, additionally, depend upon the amount of friction drag and the magnitude of the electromagnetically transmitted torque applied through the operation of the control torquer device 28. Assuming that the housing 30, and hence the control shaft 24 connected thereto, is occupying the desired angular position to achieve drilling in the desired direction, then it is desired that the torque forces applied to the housing 30 by the impellers 36, 40, in combination with other, for example frictional, torque forces experienced by the housing 30 balance one another so that no net torque force is applied to the housing 30 to cause rotation thereof. This can be achieved by appropriately controlling the control torquer device 28 to control the magnitude of the torque force applied to the housing 30 by the first impeller 26. In the event that the housing 30 is not in the desired angular position, then the magnitude of the torque force applied by the first impeller 26 through the control torquer device 28 is adjusted to cause angular movement of the housing 30 to take place to move the housing 30 towards the desired angular position. Once this position has been achieved, the control torquer device 28 is controlled in such a manner as to allow this portion to be maintained.

As the second impeller 40 is provided, it will be appreciated that this movement may be either clockwise or anticlockwise movement.

In practise, the magnitude of the torque force applied to the housing through the control torquer device 28 is likely to be continuously or substantially continuously varying to allow the position of the housing 30 to be continuously or substantially continuously adjusted.

The design of the first impeller 26 is preferably such that the maximum achievable torque force applied to the housing 30 through the control torquer device is greater than the torque applied to the housing 30 by the second impeller 40 and other torques normally experienced by the housing 30, for example due to friction in the bearing located in the hangers 32, 34, for the entire operating fluid flow range of the tool.

By using two impellers, the tool is suitable for use in a wide range of applications, but by having only a single control torquer device, cost and maintenance are reduced.

It will be appreciated that a range of modifications or alterations may be made to the basic tool design described hereinbefore. For example, the positions of the first and second impellers 36, 40 could be reversed. Further, the second impeller 40 could, if desired, be located at an intermediate position, or could be mounted upon the control shaft 24. The orientation of the impeller blades may be such that the first impeller 36 is arranged to apply a clockwise acting torque, the second impeller 40 applying an anti-clockwise torque. Alternatively, the orientation may be reversed. Embodiments are also possible in which the first and second impellers 36, 40 apply torque forces acting in the same direction as one another. The impellers 36, 40 may include associated stators which could, for example, be mounted upon the tool collar 28 and arranged to divert the flow of fluid towards the impeller blades. Alternatively, the stators could be mounted upon or form part of the hangers 32, 34.

The hangers 32, 34 may be mounted in position using a range of techniques. For example, they could be secured in position by bolts or pins passing through the tool collar 28. Alternatively, they could be in threaded engagement with the tool collar 28. The upper hanger 32 could be arranged so as to be free to slide, axially, within the tool collar 28.

The bearings incorporated into the hangers 32, 34 and associated with the control torquer device and first impeller may be arranged to be lubricated by the drilling fluid, or alternatively could be lubricated by oil using bellows, pistons or the like to accommodate the lubrication oil.

It may be possible to control the steering direction by controlling the operation of the tool in response to variations in the rate or pressure at which drilling fluid is supplied. Such techniques may allow the steering direction to be controlled in the relatively simple and convenient manner. For example, a pressure sensor could be incorporated into the housing 30 to measure the fluid supply pressure, the output of the sensor being used in controlling the operation of the control torquer device. Alternatively, the rotary speed of the first impeller may be measured to allow the fluid supply rate to be sensed, and the tool operated accordingly. It may be possible to achieve this by monitoring the power consumption of the control torquer device. Other possibilities include sensing the rotary speed of the housing relative to the tool collar. The supply of control signals in this manner may be achieved either during drilling, or at times when drilling is not taking place.

A range of other modifications and alterations are also possible within the scope of the invention. Further, although the invention is described hereinbefore in relation to a specific drilling system, it will be appreciated that the invention may also be applied to other forms of steerable or directional drilling system. For example, in order to reduce the distance between the bias unit and the bit, the bias unit may be located between the motor and the bit. Further, in some cases, the motor may be omitted all together, and the rotation of the drill pipe/string relied upon.

1. A roll stabilised unit comprising a tool housing rotatably mounted within a tool collar, the tool housing having rotatably mounted thereon a first impeller, a variable torque transmission arrangement being provided to allow the torque transmitted from the first impeller to the housing to be controlled, and a second impeller fixed relative to the housing so as to be rotatable with the housing.

2. A unit according to claim 1, wherein the first and second impellers include impeller blades, the blades of the first impeller being angled relative to those of the second impeller such that, in use, the torque forces applied to the housing by the first and second impellers are in opposing directions.

3. A unit according to claim 2, wherein the first and second impellers are arranged such that the maximum torque capable of being applied to the housing by the first impellor is greater than the opposing torque experienced by the housing.

4. A unit according to claim 1, wherein the variable torque transmission arrangement comprises a control torquer device.

5. A unit according to claim 4, wherein the control torquer device is electromagnetically operable to vary the torque transmitted to the housing.

6. A unit according to claim 1, wherein rotation of the first impeller relative to the housing generates electricity.
